(19) United States
(12) Patent Application Publication
(10) Pub. No.: US 2010/0229672 A1
(43) Pub. Date: Sep. 16, 2010

(54) ACTUATING MECHANISM FOR MOVING AN UPWARDLY MOVABLE FLAP OF A PIECE OF FURNITURE

(76) Inventor: Harald BRUNNMAYR, Horbranz (AT)

Correspondence Address: WENDEROTH, LIND & PONACK, L.L.P., 1030 15th Street, N.W.,, Suite 400 East, Washington, DC, 20005-1503, US

(21) Appl. No.: 12/778,280

(22) Filed: May 12, 2010

Related U.S. Application Data
(63) Continuation of application No. PCT/AT2008/000388, filed on Oct. 24, 2008.

(30) Foreign Application Priority Data
Dec. 19, 2007 (AT) A 2064/2007

(51) Int. Cl. E05F 15/12; A47B 96/00; A47B 97/00; E05D 15/46

(52) U.S. Cl. 74/490.07; 74/479.01

(57) ABSTRACT

An actuating mechanism for moving a highly movable flap of a piece of furniture includes a main body intended for attachment to a furniture body. An actuating arm for moving the flap is mounted at one end on a bearing axis of the main body and at the other end on a bearing axis of a fitting part intended for attachment to the flap. An additional control arm for moving the flap is provided, wherein during the movement of the control arm the effective lever arm length of the control arm can be varied, and the effective lever arm length of the control arm is shortened when opening the actuating arm.

The present invention relates to an actuating mechanism for moving an upwardly movable flap of an article of furniture, comprising a main body to be fixed to a furniture body, wherein an actuating arm for moving the flap is mounted on the one hand at a mounting axis of the main body and on the other hand at a mounting axis on a fitment to be fixed to the flap and wherein there is further provided an additional control arm for moving the flap, wherein during the movement of the actuating arm the effective lever arm length of the control arm is variable.

Furthermore the invention concerns an article of furniture comprising an actuating mechanism of the kind to be described, which is provided for moving an upwardly movable flap.

Actuating mechanisms of that kind are used for moving flaps of articles of furniture which are movably mounted between a vertical position in which a storage compartment of the furniture body is closed and an upwardly directed open position. When the flap is opened it can occur that the flap performs a considerable lifting-away movement in relation to the face of the furniture carcass, which is perceived by the user as being unpleasant as on the one hand a relatively large amount of free space has to be provided and on the other hand there is also the danger that the user in front of the carcass of the cupboard can suffer injuries to the head due to excessive outward pivotal movement of the flap. As a result, the operator during the opening movement of the flap will intuitively dodge rearwardly out of the way when the flap moves at the level of his head.

EP 0 952 290 A2 and EP 1 785 565 A2 disclose fittings for upwardly moving furniture flaps, comprising a spring-loaded actuating arm and a control mechanism in the form of two hingedly interconnected pivot levers, the effective lever arm length of which is increased in the opening movement of the flap. A disadvantage there is the risk that the flap of the article of furniture can easily collide with the head of the user in the course of the opening movement.

It is therefore an object of the present invention to provide an actuating mechanism of the general kind set forth in the opening part of this specification, with an improved kinematics for substantially avoiding the above-indicated disadvantages.

In accordance with the invention in an advantageous configuration this is achieved in that the effective lever arm length of the control arm is shortened when the actuating arm is opened.

The basic concept of the present invention therefore involves shortening the effective lever arm length formed by the control arm in the course of the opening movement of the flap. In that case the effective lever arm length can be in the form of a function of the rotational angle of the actuating arm which supports the movement of the flap in respect of force. In this connection it is possible to provide in particular a non-linear progression, namely the effective lever arm length of the control arm changes less in a first opening angle range of the actuating arm, that adjoins the closed position, than in a second opening angle range which adjoins same and which extends towards the completely open position of the actuating arm.

In that way it is possible for the flap to be moved in a first pivotal range starting from the fully closed position in parallel relationship with itself (that is to say substantially parallel to the face of the furniture body or carcass) and then to pivot away over the furniture carcass, in which case the flap in a region immediately in front of the fully open position performs a relatively great pivotal movement due to a corresponding strongly pronounced change in the length of the control arm.

The proposed construction provides on the one hand that the lifting-away movement of the flap in relation to the face of the furniture carcass can be kept small, while on the other hand it is thereby also possible for the flap not to reach the maximum room height by a correspondingly great pivotal movement in the region immediately in front of the completely open position so that in its open position the flap can be still easily actuated by the operator.

A further advantage is also that, in the case of a motor-driven flap—particularly during the closing movement—the risk that the lower edge of the flap hits the user on the head is reduced. The control arm is one the one hand pivotally connected to a bearing axis associated with the furniture carcass, on the on the other hand pivotally connected to the flap. The invention now provides that the relative spacing between the carcass-side bearing axis of the control arm and the flap-side bearing axis of the control arm is altered, preferably shortened, in the course of the pivotal movement of the actuating arm.

In structural respects the configuration can be such that the control arm comprises at least two portions movable relative to each other. In that respect relative mobility is to interpreted as meaning that all possible mounting options of the at least two portions relative to each other are embraced, which can involve a reduction in the spacing of the carcass-side and the flap-side bearing axis of the control arm during the pivotal movement of the flap.

In an possible embodiment it can be provided that said at least two portions are connected together by way of a hinge axis, wherein there is provided an additional intermediate lever which is operative between the hinge axis of the at least two portions and a hinge axis on the actuating arm. In that case the additional intermediate lever takes over the function of providing positive control, by which the two hingedly interconnected lever portions are folded during the opening movement of the actuating arm. In that case the lever portions—starting from the completely closed position of the actuating arm—are initially only slightly angled, but in a second pivotal range as far as the completely open position of the actuating arm they are relatively greatly folded, whereby it is possible to implement the desired opening progression for the flap.

In accordance with a further embodiment of the invention it can be provided that the relative position of the at least two portions relative to each other can be varied by a drive device, preferably an electric drive. In a further embodiment, the electric drive performs adjustment of the relative position of the at least two portions relative to each other by way of a transmission mechanism. In that case the electric drive for altering the spacing between the carcass-side bearing axis and the flap-side bearing axis of the control arm can be so actuated that in a first rotary angle range of the actuating arm, starting from the completely closed position thereof, the electric drive is either not moved at all or is moved only slightly, while in an opening angle range of the actuating arm, which is right in front of the completely open position of the actuating arm, a more greatly pronounced relative reduction in length of the control arm is effected.

In accordance with a first variant of the invention, the control arm can have a carcass-side bearing axis arranged at or in a main body of the actuating mechanism. Alternatively the bearing axis of the control arm can also be arranged on a mounting portion separate from the main body of the actuating mechanism, on the article of furniture. In that case the carcass-side bearing axis of the control arm can be arranged in the uppermost region of the carcass of the article of furniture and preferably in the region of the front face of the carcass of the article of furniture. The carcass-side bearing axis and the flap-side bearing axis of the actuating arm thus form a hinge quadrilateral with the carcass-side bearing axis and the flap-side bearing axis of the control arm, wherein the area formed by the hinge quadrilateral can be increased by the arrangement of the carcass-side mounting axis in the uppermost and foremost region of the carcass of the article of furniture, whereby it is possible to implement advantageous lever ratios for the movement of the flap.

Further details and advantages of the present invention will be apparent from the specific description hereinafter. In the drawings:

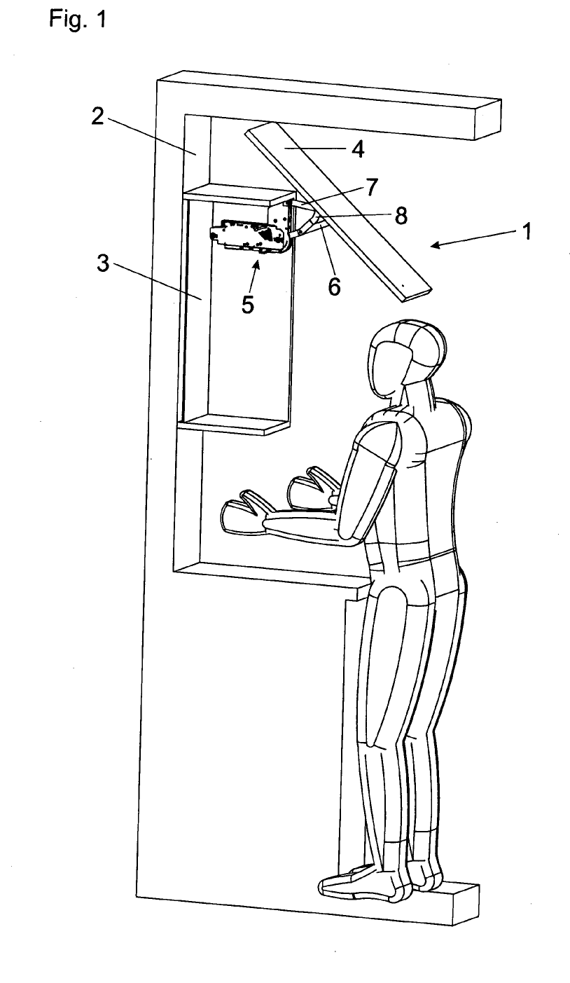

FIG. 1 shows a perspective view of a wall-mounted article of furniture having an actuating mechanism for the movement of an upwardly pivotable flap,

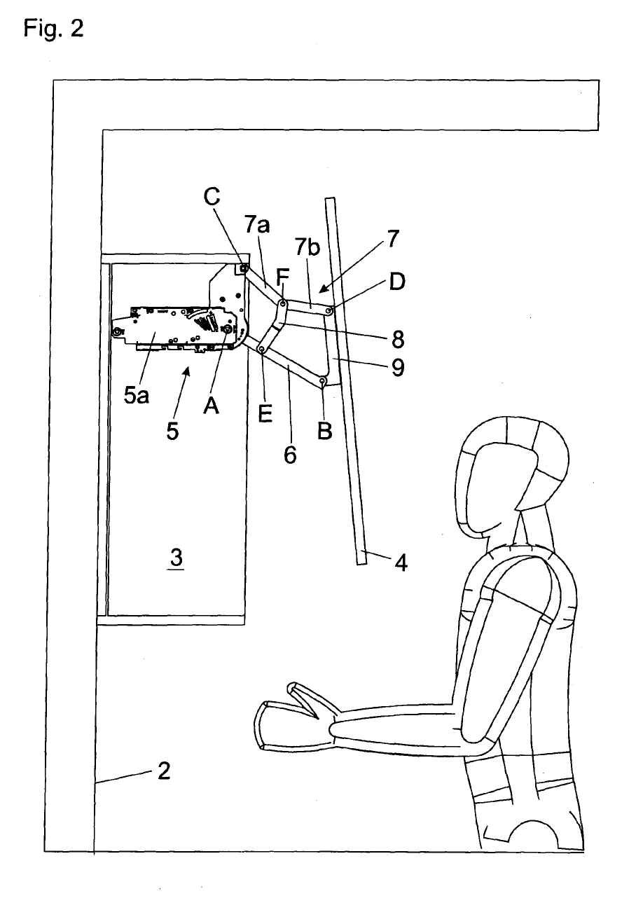

FIG. 2 shows a side view of the arrangement of FIG. 1,

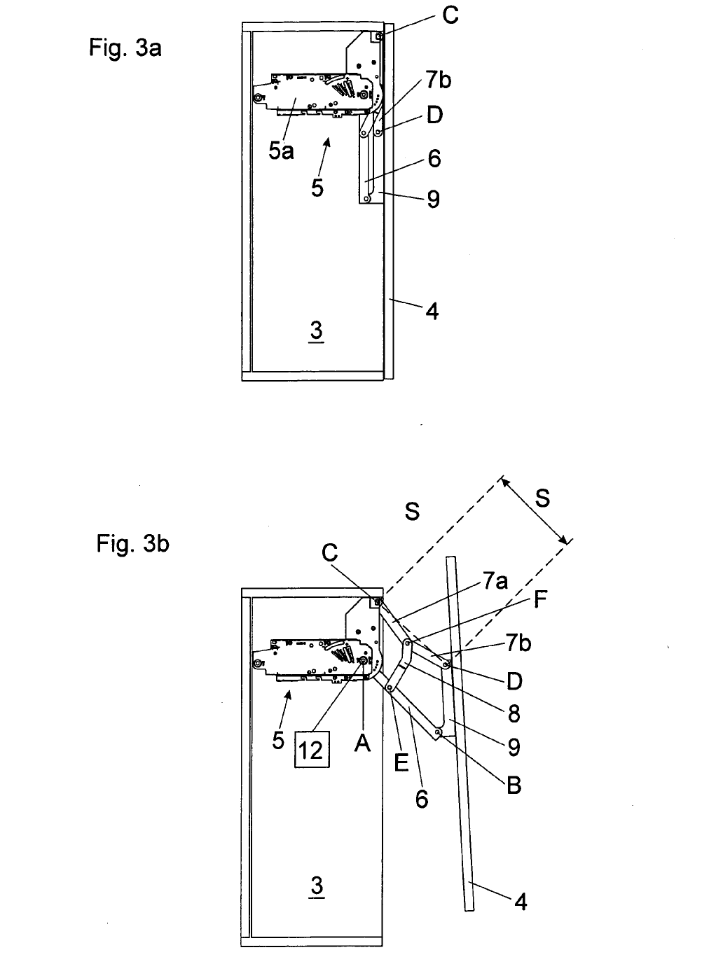

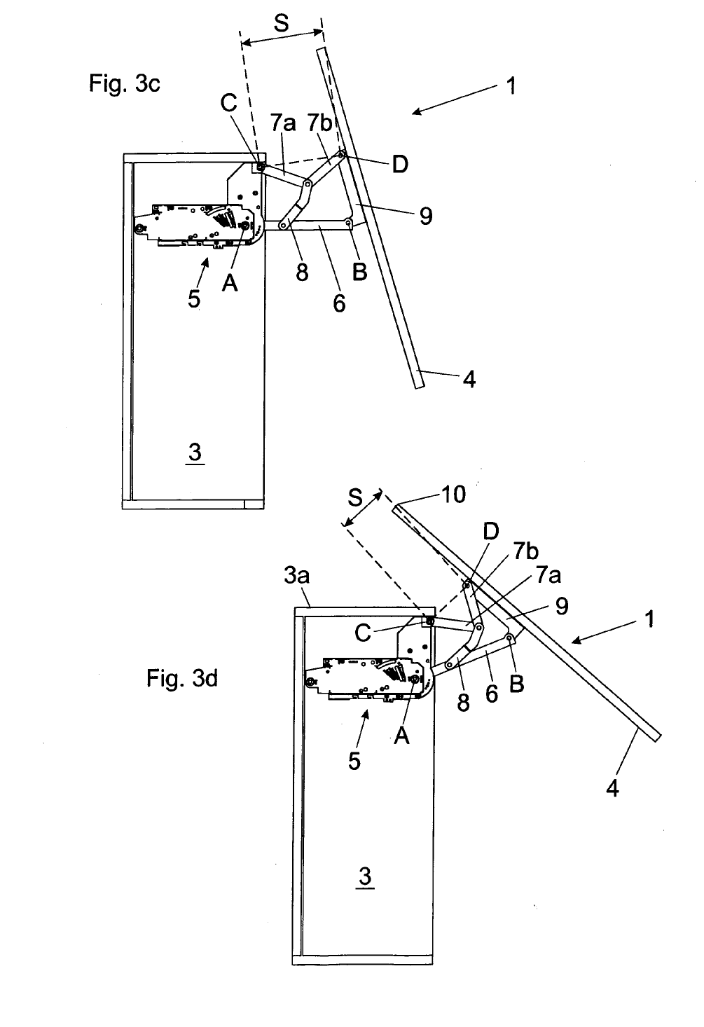

FIGS. 3a-3d show the opening progression of the flap in time sequences,

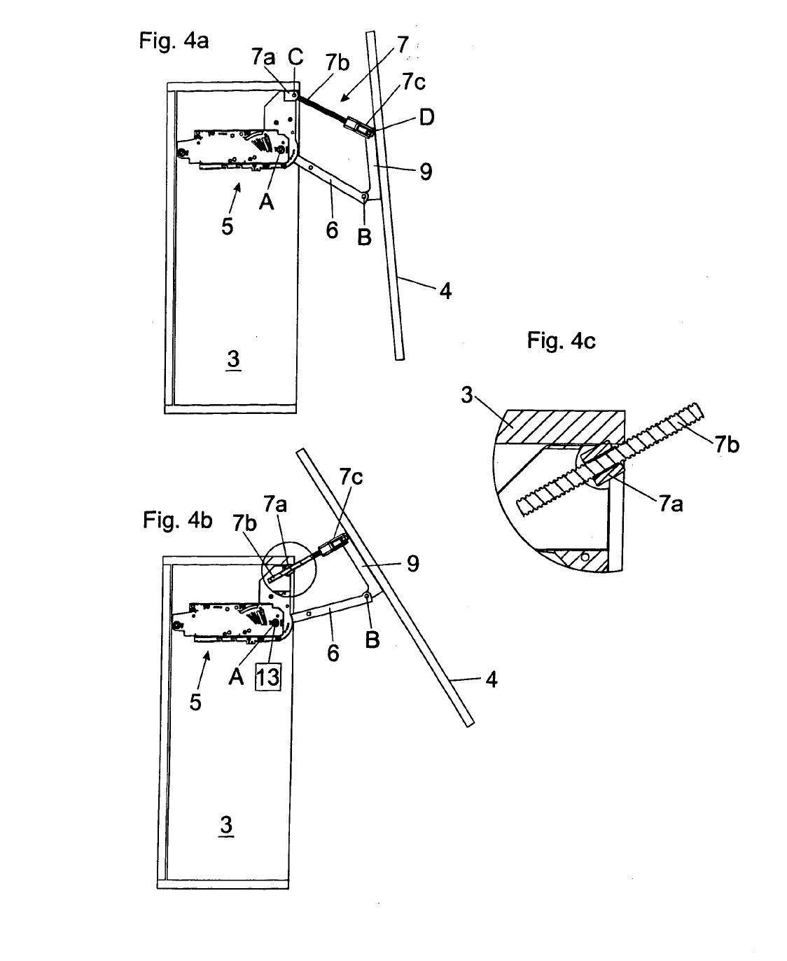

FIGS. 4a-4c show an alternative embodiment having a control arm which includes a spindle drive,

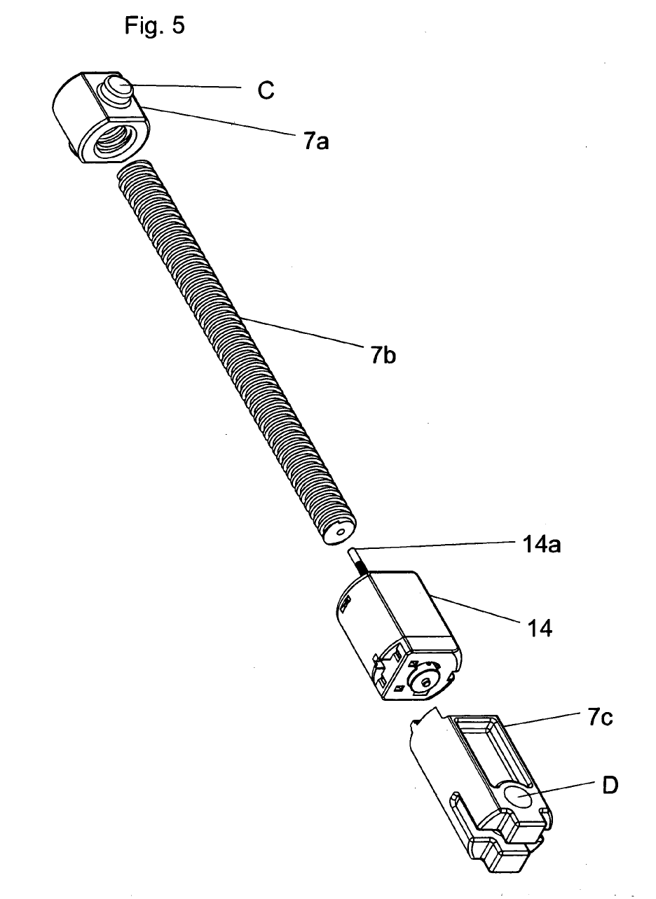

FIG. 5 shows a perspective view of the control arm with a motor-operable spindle drive,

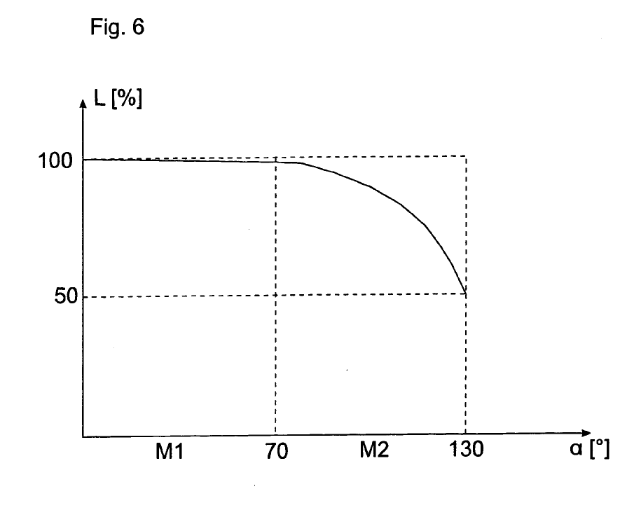

FIG. 6 shows a diagram illustrating the curve configuration of the effective lever arm length of the control arm as a function of the opening angle of the actuating arm.

FIG. 1 shows a perspective view of an article of furniture 1 in the form of a cupboard which is fixed to a wall 2 and which in particular is used as an upper cabinet in a kitchen. The article of furniture 1 includes a body or carcass 3 which is to be fixed to the wall 2, to the side wall of the furniture 1 there is mounted an actuating mechanism 5 according to the invention for displacement of an upwardly pivotable flap 4. In the closed position, the flap 4 assumes a substantially vertical position and, starting from that vertical position, is movable into an upwardly displaced open position. For reasons of clarity of the drawing only a part of the flap 4 and the furniture carcass 3 is shown. An actuating mechanism 5 can also be arranged at the inside of the oppositely disposed side wall of the article of furniture 1. The actuating mechanism 5 comprises an actuating arm 6 which can be acted upon by a drive device which is not shown in greater detail here (spring device and/or electric motor). As a result, the actuating arm 6 therefore assists with the movement of the flap 4, in respect of the force involved there. In addition to the actuating arm 6 there is also provided a control arm 7 which influences the motion characteristic of the flap 4 during its travel movement. During the opening progression of the flap 4, conventional structures can involve a considerable lifting-away movement of the flap 4 in relation to the front face of the furniture carcass 3, so that the user runs the risk of suffering injury. The invention now proposes reducing the effective lever arm length of the control arm 7 during the opening progression of the flap 4, and that is implemented by the intermediate lever 8. The intermediate lever 8 is operative between the actuating arm 6 and the control arm 7 so that this provides for positive displacement of the control arm 7, as is to be described in greater detail with reference to following Figures.

FIG. 2 shows the arrangement of FIG. 1 in a side view. Mounted to at least one side wall of the furniture carcass 3 is an actuating mechanism 5 which includes a drive device which is not shown in greater detail (spring device and/or electric motor) for actuating the actuating arm 6. The actuating arm 6 is arranged at the carcass side at or in a main body 5a at a bearing axis A while the other distal end of the actuating arm 6 is hingedly mounted to the flap-side fitment 9 at a bearing axis B. In addition to the actuating arm 6 there is also provided a control arm 7 which in the illustrated embodiment includes two portions 7a and 7b which are hingedly connected together at the hinge axis F. The control arm 7 with the two portions 7a, 7b is therefore mounted at the carcass side at the bearing axis C and at the flap side at the fitment 9 at the bearing axis D. A—preferably cranked—intermediate lever 8 connects the actuating arm 6 at the hinge axis E to the control arm 7 at the hinge axis F. Starting from the fully closed position of the flap 4 the two portions 7a and 7b of the control arm 7 are only insignificantly folded, whereby substantially parallel guidance for the flap 4 is possible in relation to the front face of the furniture carcass 3. As from a given angle of pivotal movement of the actuating arm 6 (for example from 70° in relation to the vertical), a more greatly pronounced bending movement of the two portions 7a and 7b is effected by the intermediate lever 8, whereby the flap 4 performs a correspondingly great pivotal movement and is pivotable rearwardly beyond the furniture carcass 3.

FIGS. 3a-3d show the opening progression of the flap 4 in time sequences. FIG. 3a shows the flap 4 in the completely closed position. The actuating mechanism 5 with its actuating arm 6 for supporting movement of the flap 4 is fixed to a side wall of the furniture carcass 3. Of the control arm 7, it is possible to see the portion 7b which is pivotally connected with respect to the bearing axis D of the flap-side fitment 9. The reference C denotes the carcass-side bearing axis of the control arm 7, which can be arranged either at the main body 5a of the actuating mechanism 5 or also separately therefrom at the furniture carcass 3. The relative spacing S, shown in FIG. 5b of the two bearing axes C and D of the control arm 7, which can be reduced in the course of the opening movement of the flap 4, is of significance.

FIG. 3b shows the flap 4 in a slightly open position, wherein the flap 4 is movable in a first pivotal range substantially parallel to itself and performs a movement of lifting away from the furniture carcass 3. In that first pivotal range of the flap 4 the intermediate lever 8 arranged at the hinge axis E on the actuating arm 6 causes only an insignificant folding movement of the two portions 7a, 7b of the control arm 7. Reference S denotes the relative spacing (normal spacing) of the two bearing axes C and D of the control arm 7. In addition a diagrammatically illustrated electric motor 12 can also be operative on the bearing axis A of the actuating arm 6 arranged on the main body 5a.

FIG. 3c shows a movement of the flap 4, which is pursued from FIG. 3b, the two parts 7a, 7b of the control arm 7 were admittedly bent somewhat more greatly by the intermediate lever 8, but in comparison with FIG. 3b that involves only an immaterial change in the spacing S between the carcass-side bearing axis C and the flap-side bearing axis D of the control arm 7.

FIG. 3d shows an open position of the flap 4, which is continued from FIG. 3c. It is possible to see a relatively severe bending motion of the two portions 7a, 7b of the control arm 7, which is caused by the cranked intermediate lever 8. It is possible to see the spacing S, which is markedly reduced in comparison with FIG. 3c, between the carcass-side bearing axis C and the flap-side bearing axis D of the control arm 7. Starting from the position of the flap 4 as shown in FIG. 3d, the flap 4 can be moved into the completely open position, wherein the proposed kinematics of the actuating mechanism 5 means that the upper edge 10 of the flap 4 can be moved relatively closely to the cupboard top 3a of the carcass 3 of the article of furniture 1.

FIGS. 4a-4c show a side view of an alternative embodiment of the invention. As in the preceding embodiments the actuating mechanism 5 includes an actuating arm 6 which is pivotally arranged at the carcass side at the bearing axis A and at the flap side at the bearing axis B. The control arm 7 in contrast includes a portion 7a which is in the form of a spindle nut and which at the same time forms the bearing axis C of the control arm 7. In addition the control arm 7 comprises a spindle 7b movable relative to the portion 7a (spindle nut). Moreover, the control arm 7 includes a mounting portion 7c which is pivotally fixed at the bearing axis D to the flap-side fitment 9. The mounting portion 7c serves to receive an electric drive by which the portion 7b (spindle) is rotatable and is thereby movable in variable-length relationship with respect to the portion 7a (spindle nut). In that case the electric drive arranged at the mounting portion 7c can be operated again in dependence on the angular position of the actuating arm 6 so that, starting from the completely closed position of the flap 4, there is only a slight change in length of the control arm 7, while from a predetermined or predeterminable opening angle of the actuating arm 6 towards the fully open position of the flap 4, the effective lever arm length of the control arm 7 is altered more greatly than in the first pivotal range of the flap 4.

FIG. 4b shows a control arm 7 which is shortened in comparison to FIG. 4a, the control arm 7 having a reduced effective lever arm length, as the portion 7b (spindle) projects into the interior of the furniture carcass by virtue of the motor displacement produced. It will be appreciated that it is also possible for the electric drive integrated in the mounting portion 7c also to be arranged at the body side. Equally, instead of the illustrated spindle drive, it is also possible to provide a linearly movable rack with a rotatable pinion for adjusting the lever arm length of the control arm 7. Reference 13 denotes a schematically depicted device for detecting the angular position of the actuating arm 6, by which the electric drive for displacement of the two portions 7a, 7b relative to each other is selectively actuable.

FIG. 4c shows a view on an enlarged scale of the region circled in FIG. 4b, with a carcass-side spindle nut 7a and a spindle 7b which projects into the interior of the furniture carcass 3.

FIG. 5 shows a possible embodiment of a spindle drive for implementing the control arm 7. An electric drive 14 with drive shaft 14a, which can be arranged at or in the mounting portion 7c, acts directly or by way of a transmission mechanism on the portion 7b which is in the form of a spindle. The effective lever arm length of the control arm 7 can be altered, preferably shortened by a rotary movement of the spindle, produced by the electric drive 14.

FIG. 6 shows by way of example the variation in the effective lever arm length of the control arm 7 as a function of the opening angle α of the actuating arm 6. The actuating arm angle α is specified at the abscissa while the effective lever arm length L of the control arm is specified at the ordinate (in %). In a first opening angle range M1 of the actuating arm 6, starting from the completely closed position, the control arm 7 substantially retains its effective lever arm length L, a parallel movement of the flap being made possible. From approximately half the opening angle of the actuating arm a (for example from about)60° a second pivotal range M2 adjoining the first pivotal range M1 involves a pronounced reduction in the length of the control arm 7, whereby the flap 4 folds greatly beyond the furniture carcass 3. The effective lever arm length L of the control arm 7 can be about 50% of the original effective lever arm length, in the completely open position of the actuating arm 6. It should be noted that in that case numerous alternative configurations are possible for the person skilled in the art, for implementing the curve configuration.

The invention is not limited to the illustrated embodiments but includes or extends to all variants and technical equivalents which can fall within the scope of the accompanying claims. The positional references adopted in the description such as for example up, down, lateral and so forth are related to the figure being directly described and illustrated and upon a change in position are to be appropriately transferred to the new position. In the illustrated embodiments for reasons of simplicity and greater ease of understanding a control arm 7 which is shortened in the course of the movement travel of the flap 4 and by which the flap 4 is pivotable beyond the furniture carcass 3 in the course of the flap opening progress was shown in each case. It will be appreciated that it is also in accordance with the invention for the effective lever arm length L of the control arm 7 to increase upon opening of the flap 4, whereby during its opening progress the flap 4 is also pivotable over a user disposed in front of the furniture carcass 3.

1. An actuating mechanism for moving an upwardly movable flap of an article of furniture, comprising:
a main body to be fixed to a furniture carcass;
an actuating arm for moving the flap, said actuating arm being mounted on the one hand at a bearing axis of said main body and on the other hand at a bearing axis on a fitment to be fixed to said flap;
the actuating mechanism further comprises an additional control arm for moving the flap, said control arm having an effective lever arm length, said effective lever arm length can be varied upon movement of said actuating arm;
wherein said the effective lever arm length of said control arm is shortened when said actuating arm is opened.

2. The actuating mechanism according to claim 1, wherein said control arm has at least two portions being movable relative to each other.

3. The actuating mechanism according to claim 2, wherein said at least two portions are connected together by way of a hinge axis, wherein there is provided an additional intermediate lever which is operative between said hinge axis of said at least two portions and a hinge axis on said actuating arm.

4. The actuating mechanism according to claim 3, wherein said hinge axis of said intermediate lever with respect to said actuating arm is arranged approximately in the central region between the said two mounting axes of said actuating arm.

5. The actuating mechanism according to claim 2, wherein a relative position of said at least two portions relative to each other can be varied by a drive device.

6. The actuating mechanism according to claim 5, wherein said drive device comprises an electric drive.

7. The actuating mechanism according to claim 6, wherein said electric drive performs displacement of a relative position of said at least two portions relative to each other by way of a transmission mechanism.

8. The actuating mechanism according to claim 7, wherein said transmission mechanism includes a spindle drive.

9. The actuating mechanism according to claim 6, wherein there is provided a device for detecting an angular position of said actuating arm, wherein said electric drive for displacement of said two portions is controllable in dependence on that angular position of said actuating arm.

10. The actuating mechanism according to claim 1, wherein said effective lever arm length of said control arm changes less in a first opening angle range of said actuating arm, adjoining the closed position, than in a second opening angle range which adjoins same and which extends to the completely open position of said actuating arm.

11. The actuating mechanism according to claim 1, wherein said control arm has a carcass-side bearing axis which is arranged substantially in the uppermost region of the furniture carcass and in the region of the front face of the furniture carcass.

12. The actuating mechanism according to claim 1, wherein said control arm has a flap-side bearing axis being arranged at said fitment to be fixed to said flap.

13. The actuating mechanism according to claim 11, wherein during the opening movement of said actuating arm, a relative spacing between said carcass-side bearing axis of said control arm and said flap-side bearing axis of said control arm is variable and can be reduced.

14. The actuating mechanism according to claim 11, wherein said carcass-side bearing axis and said flap-side bearing axis of said control arm form a hinge quadrilateral with said flap-side bearing axis and said flap-side bearing axis of said actuating arm (6).

15. The actuating mechanism according to claim 1, wherein said control arm is arranged above said actuating arm.

16. An article of furniture having an actuating mechanism according to claim 1.
